(19) United States
(12) Patent Application Publication
(10) Pub. No.: US 2022/0129179 A1
(43) Pub. Date: Apr. 28, 2022

(54) DATA PROCESSING APPARATUS, DATA PROCESSING SYSTEM INCLUDING THE SAME, AND OPERATING METHOD THEREOF

(71) Applicant: SK hynix Inc., Icheon-si (KR)

(72) Inventor: Jung Min CHOI, Icheon-si (KR)

(21) Appl. No.: 17/228,323

(22) Filed: Apr. 12, 2021

(30) Foreign Application Priority Data
Oct. 22, 2020 (KR) 10-2020-0137477

(51) Int. Cl. G06F 3/06

(52) U.S. Cl. CPC G06F 3/0644; G06F 3/0653; G06F 3/067; G06F 3/0659; G06F 3/0604; G06F 3/0635

(57) ABSTRACT

A data processing apparatus includes a memory pool including a plurality of memory modules; and a controller coupled to the memory pool through a bus. The controller is configured to collect a status of a computing resource of the data processing apparatus, construct meta information indicating the status of the computing resource, and transmit the meta information to the host device coupled through a network.

### CROSS-REFERENCES TO RELATED APPLICATION

This patent document claims priority under 35 U.S.C. § 119(a) to Korean Patent Application Number 10-2020-0137477, filed on Oct. 22, 2020, in the Korean Intellectual Property Office, which is incorporated herein by reference in its entirety.

### TECHNICAL FIELD

The technology and implementations disclosed in this patent document generally relate to a semiconductor integrated device, and more particularly, to a data processing apparatus, a data processing system including the same, and an operating method thereof.

### BACKGROUND

As the demand and importance for artificial intelligence applications, big data analysis, and graphic data processing have been increased, computing systems capable of effectively processing large amounts of data using more computing resources, high-bandwidth networks, and high-capacity and high-performance memory devices are demanded.

Since there are limitations to expand memory capacity of a processor to process large amounts of data, a protocol for expanding the memory capacity through a fabric network has been developed. Since fabric-attached memories (FAMs) are theoretically not limited in capacity expansion, the FAMs have a structure suitable for processing large amounts of data. However, as the number of accesses of a host device to the FAMs is increased, the performance deterioration due to data movement, power consumption, and others may occur.

Therefore, current computing systems have evolved into data-centric computing systems or memory-centric computing systems that are capable of processing massive data in parallel at high speed. In the data (or memory) computing system, a processor which performs an operation is arranged in a memory device or arranged close to the memory device, and thus the processor may offload and perform tasks (operation processing, application processing) requested by the host device.

Under near data processing (NDP) environments, there is a need for a method for improving data processing performance by simplifying communication between a host device and a data processing apparatus.

### SUMMARY

In an embodiment of the disclosed technology, a data processing apparatus may include: a memory pool including a plurality of memory modules; and a controller coupled to the memory pool through a bus. The controller is configured to collect a status of a computing resource of the data processing apparatus, construct meta information indicating the status of the computing resource, and transmit the meta information to the host device coupled through a network.

In an embodiment of the disclosed technology, a data processing system may include: a host device; and a plurality of data processing apparatuses coupled to the host device through a network. At least one of the plurality of data processing apparatuses includes: a memory pool including a plurality of memory modules; and a controller coupled to the memory pool through a bus, and configured to monitor and collect a status of a computing resource of the at least one of the plurality of data processing apparatuses, construct meta information indicating the status of the computing resource, and transmit the meta information to the at least one host device.

In an embodiment of the disclosed technology, a data processing system may include: a data processing apparatus including a controller coupled to a memory pool including a plurality of memory modules through a bus, the controller configured to collect a status of a computing resource of the data processing apparatus, construct meta information indicating the status of the computing resource, and transmit the meta information; and a host device coupled to the data processing apparatus through a network and configured to select a data processing apparatus based on the meta information and offload an application processing request to a selected data processing apparatus.

In an embodiment of the disclosed technology, an operating method of a data processing system may include constructing, by a controller included in a data processing system that includes a plurality of memory modules coupled to the controller through a bus, meta information by collecting a status of a computing resource of the data processing system; and transmitting, by the controller, the meta information to a host device coupled to the data processing system through a network

These and other features, aspects, and embodiments are described in more detail in the description, the drawings and the claims.

### BRIEF DESCRIPTION OF THE DRAWINGS

The above and other aspects, features and advantages of the subject matter of the present disclosure will be more clearly understood from the following detailed description taken in conjunction with the accompanying drawings.

FIG. 1 is a diagram illustrating a configuration of a data processing apparatus based on an embodiment of the disclosed technology.

FIG. 2 is a diagram illustrating a configuration of a meta information handler based on an embodiment of the disclosed technology.

FIGS. 3 and 4 are diagrams illustrating configurations of meta information packets based on embodiments of the disclosed technology.

FIG. 5 is a flowchart explaining an operating method of a data processing apparatus based on embodiments of the disclosed technology.

FIG. 6 is a diagram illustrating a configuration of a data processing system based on an embodiment of the disclosed technology.

FIG. 7 is a diagram illustrating a configuration of a host device based on an embodiment of the disclosed technology.

FIG. 8 is a diagram illustrating a configuration of a data processing system based on an embodiment of the disclosed technology.

FIG. 9 is a flowchart explaining an operating method of a host device based on embodiments of the disclosed technology.

FIG. 10 illustrates an example of a stacked semiconductor apparatuses in accordance with an embodiment of the disclosed technology.

FIG. 11 illustrates another example of a stacked semiconductor apparatus in accordance with an embodiment of the disclosed technology.

FIG. 12 illustrates yet another example of a stacked semiconductor apparatus in accordance with an embodiment of the disclosed technology.

FIG. 13 illustrates an examples of a network system including a data storage device in accordance with an embodiment of the disclosed technology.

### DETAILED DESCRIPTION

Various embodiments of the disclosed technology are described in detail with reference to the accompanying drawings. s.

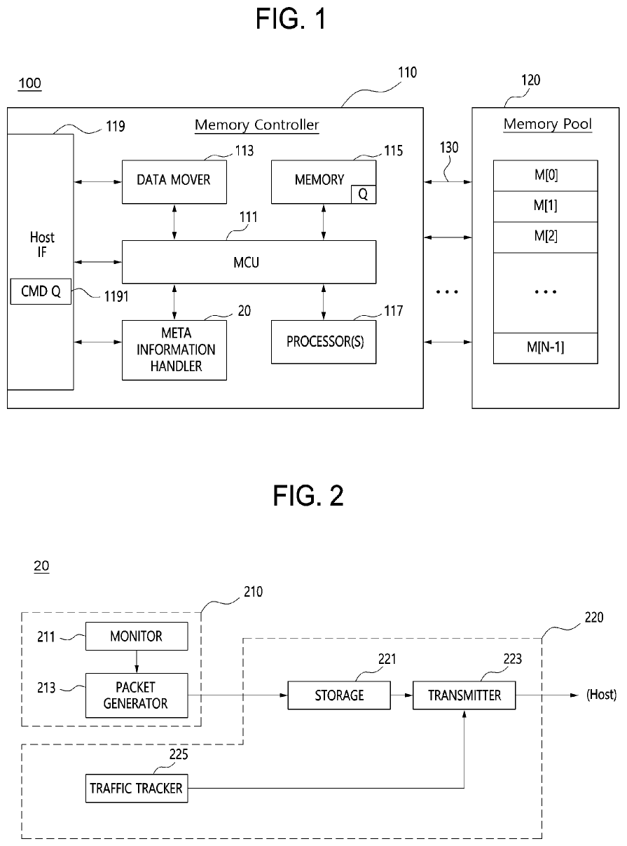

FIG. 1 is a diagram illustrating a configuration of a data processing apparatus based on an embodiment of the disclosed technology.

Referring to FIG. 1, a data processing apparatus 100 according to an embodiment may include a memory controller 110 and a memory pool 120.

The memory controller 110 may be coupled to the memory pool 120 through a bus 130, for example, a through silicon via (TSV) and configured to control data input/output to and from the memory pool 120. The memory controller 110 may process data by decoding a command transmitted from a host device through a fabric network. The operation of processing the data may include an operation of storing data transmitted from the host device in the memory pool 120, an operation of reading data stored in the memory pool 120, an operation of performing an operation based on the read data, and an operation of providing operated data to the host device or the memory pool 120.

The memory pool 120 may include a plurality of memory modules M[x], wherein X is an integer number of between 0 to (N-1). The memory pool 120 may have a structure that the plurality of memory modules M[X] are stacked through a bus such as TSV, but other implementations are also possible. In some implementations, the memory module may be a printed circuit board that holds memory chips. In some implementations, the memory module may include any physical device in which data is stored.

The memory controller 110 may include a micro control unit (MCU) 111, a data mover 113, a memory 115, a processor (or processors) 117, a host interface 119, and a meta information handler 20.

The MCU 111 may be configured to control an overall operation of the memory controller 110.

The host interface 119 may provide interfacing between the host device and the memory controller 110. The host interface 119 may store commands provided from the host device in a command queue 1191, schedule the commands, and provide the scheduling result to the MCU 111. The host interface 119 may temporarily store data transmitted from the host device and transmit data processed in the memory controller 110 to the host device.

The data mover 113 may read data temporarily stored in the host interface 119 and store the read data in the memory 115. The data mover 113 may transmit data stored in the memory 115 to the host interface 119. The data mover 113 may be a direct memory access (DMA) device.

The memory 115 may include a read only memory (ROM) that stores program codes (for example, firmware or software) required for an operation of the memory controller 110, code data used by the program codes, and others. The memory 115 may further include a random access memory (RAM) that stores data required for an operation of the memory controller 110, data generated by the memory controller 110, data read from the memory pool 120, data to be written in the memory pool 120, and others. Further, the memory 115 may include a meta information queue Q which stores meta information generated in the meta information handler 20.

The processor (or processors) may be configured to process an operation allocated according to a scheduling rule of the MCU 111.

The meta information handler 20 may generate a meta information packet by monitoring a status of a resource of the data processing apparatus 100 and transmit the meta information packet to the host device. In an embodiment, the meta information may include status information of a computing resource of the data processing apparatus 100 required to offload and process a request of the host device. For example, the meta information may include an identifier of the data processing apparatus 100, information indicating whether the command queue 1191 is full or empty, information indicating whether the MCU 111 is busy or idle, and/or an address of the memory module M[X] in which data to be transmitted from the host device is to be stored.

In the FAM environment in which at least one host device and at least one data processing apparatus 100 are coupled through a fabric network, the host device may need to acquire resource information including a resource status of each data processing apparatus 100 to an offload request that processes offloading of an application.

To collect the resource status of the data processing apparatus 100 at a host level, the performance of the data processing system may be deteriorated due to the communication overhead, and as the number of host devices or the data processing apparatuses 100 coupled to the fabric network is increased, the performance deterioration may be intensified.

Some implementations of the disclosed technology suggest generating meta information by a data processing apparatus and notifying the generated meta information to the host device coupled to the data processing apparatus. In some implementations, each data processing apparatus 100 may generate the meta information by collecting its own resource status and voluntarily notifying the host device of the generated meta information. Thus, before offloading the application processing to the data processing apparatus 100, the host device may receive the meta information from the plurality of data processing apparatuses 100 coupled to the host device, and select the data processing apparatus 100 suitable for offloading of the application processing based on the meta information. Accordingly, performance deterioration due to the communication overhead between the host device and the data processing apparatus 100 can be prevented.

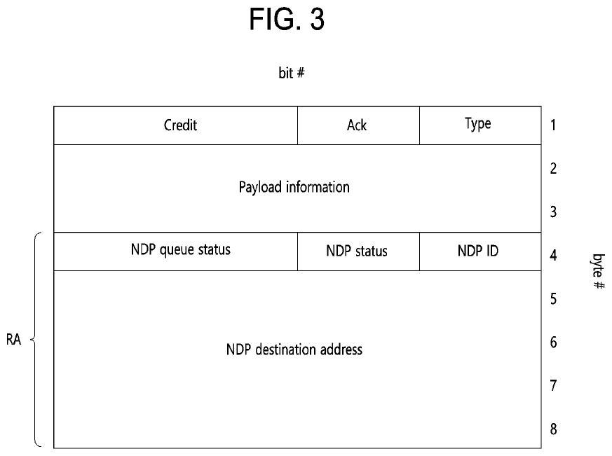

FIG. 2 is a diagram illustrating a configuration of the meta information handler 20 based on an embodiment of the disclosed technology.

Referring to FIG. 2, the meta information handler 20 may include an information collector 210 and a transmission controller 220.

The information collector 210 may include a monitor 211 configured to collect the resource status of the data processing apparatus 100 and a packet generator 213 configured to construct the resource status collected in the monitor 211 to be in a meta information format transmittable to the host device. For example, the resource status collected in the monitor 211 is constructed as a meta information packet by the packet generator 213.

The transmission controller 220 may include storage 221 configured to store the meta information packet generated in the packet generator 213 and a transmitter 223 configured to transmit the meta information packet stored in the storage 221 to the host device through the host interface 119. The storage 221 may be or include a meta information queue Q illustrated in FIG. 1, but this is not limited thereto and the storage 221 may be configured of a separate storage space provided in the meta information handler 20.

The transmission controller 220 may further include a traffic tracker 225. The traffic tracker 225 may calculate a traffic between the data processing apparatus 100 and the host device, for example, a data transmission amount per unit time. The traffic tracker 225 may control the transmitter 223 to transmit the meta information packet when the calculated traffic is less than a threshold value or is in a communication idle state.

Based on the traffic state between the data processing apparatus 100 and the host device, there may exist a data processing apparatus 100 which does not transmit the meta information packet to the host device. In some implementations, such data processing apparatus 100 may be excluded from a candidate for offloading an application. In some other implementations, the host device can access to such data processing apparatus 100 to collect the resource status.

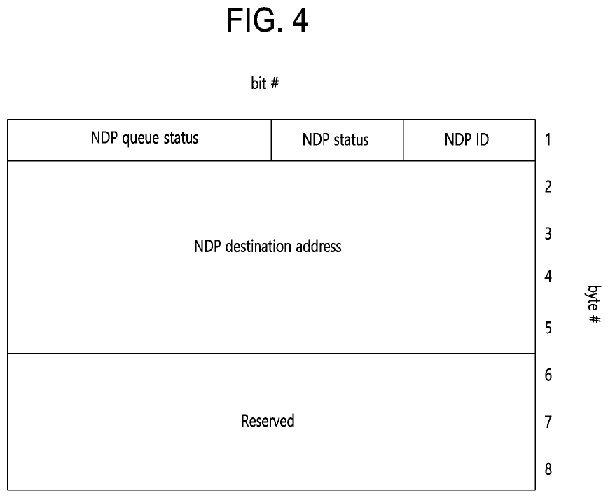

FIGS. 3 and 4 are diagrams illustrating configurations of meta information packets based on an implementation of the disclosed technology.

FIG. 3 is an illustrative diagram of a meta information packet configured by including a resource status to a reserved area RA of a protocol packet.

The protocol packet may be a packet used to transmit a request or a response signal between the data processing apparatus 100 and the host device. The protocol packet includes the reserved area RA having a certain size. In the reserved area RA, the meta information indicating the resource status is included.

As illustrated in FIG. 3, the meta information may include at least one of a field NDP queue status indicating whether the command queue 1191 is full or empty, a field NDP status indicating whether the MCU 111 is busy or idle, an identifier field NDP ID of the data processing apparatus 100, and/or an address field NDP destination address of a memory module M[X] in which data to be transmitted from the host device is to be stored.

The protocol packet may be a packet which is transmitted and received for communicating a request and a response between the host device and the data processing apparatus 100. Since the protocol packet is constructed in the transmittable format, when the meta information is transmitted using the protocol packet, a separate format for transmitting the meta information packet is not necessary and the traffic occupancy due to the separate format is not caused. Accordingly, in some implementations, when the protocol packet is used, the traffic tracker 225 may not need to monitor the traffic status.

FIG. 4 is an illustrative diagram of a meta information packet configured by using a control packet.

A control packet may be transmitted and received between the host device and the data processing apparatus 100 and the meta information packet may be configured using the control packet.

The control packet may be used to transmit control signals for requesting retransmission in case of occurrence of errors in the transmitted and received packets or requesting initialization. As compared with the case of using the protocol packet to include the meta information packet, if using the control packet to include the meta information packet, it is possible to increase the size of the meta information packet. Thus, More various and accurate resource statuses can be collected and transmitted.

When the traffic calculated through the traffic tracker 225 is less than a threshold value or is in a communication idle state, the meta information packet may be transmitted to the host device.

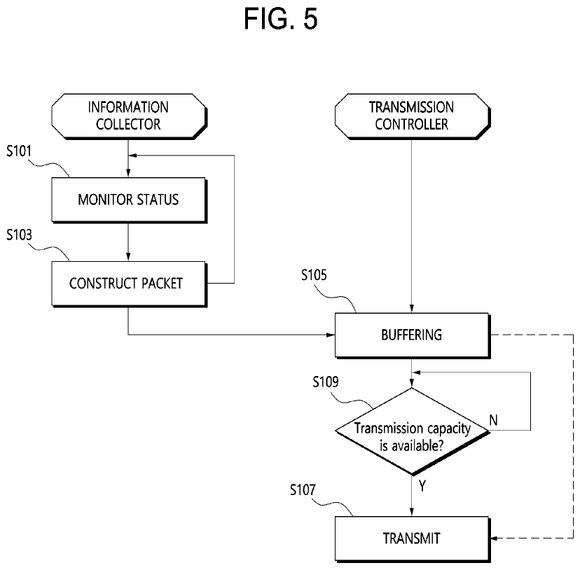

FIG. 5 is a flowchart explaining an operating method of a data processing apparatus based on an embodiment of the disclosed technology.

In some implementations, the information collector 210 of the data processing apparatus 100 may monitor the resource status of the data processing apparatus 100 (S101) and construct the resource status as a meta information format transmittable to the host device, for example, the meta information packet (S103). The resource status may include at least one of information indicating whether the command queue 1191 is full or empty, information indicating whether the MCU 111 is busy or idle, an identifier of the data processing apparatus 100, or an address of the memory module M[X] in which data to be transmitted from the host device is to be stored.

The meta information packet may be buffered in the storage 221 of the transmission controller 220 (S105). After the buffering operation, the process proceeds based on whether the meta information packet is included in the protocol packet or the control packet. As discussed above, in an embodiment, the meta information packet may be configured as a protocol packet. In this case, regardless of the traffic amount between the data processing apparatus 100 and the host device, the meta information can be transmitted when the protocol packet is transmitted to the host device (S107).

In another embodiment, the meta information packet may be configured as the control packet. In this case, after the buffering operation, the traffic tracker 225 may determine at S109 whether transmission capacity for transmitting the control packet is available based on the traffic amount between the data processing apparatus 100 and the host device et. For example, when the traffic amount is less than a threshold value or the traffic is in a communication idle state (S109:Y), the transmission controller 220 in the meta information handler 20 may transmit the buffered meta information packet to the host device (S107). When the traffic amount is not less than the threshold value and the traffic is not in the communication idle state (S109:N), the transmission controller 220 may suspend the transmission of the meta information packet until the transmission capacity is available based on the traffic amount .

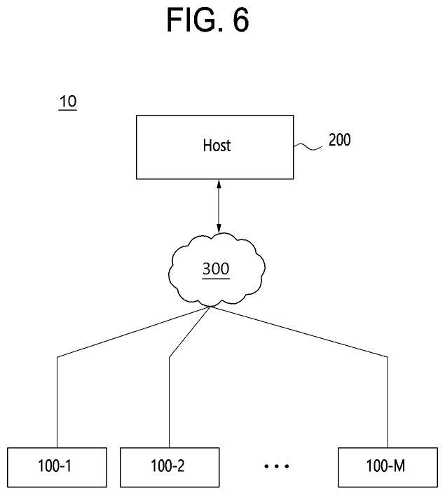

FIG. 6 is a diagram illustrating a configuration of a data processing system based on an embodiment of the disclosed technology.

In an implementation, a data processing system 10 may include a plurality of data processing apparatuses 100-1, 100-2, . . . , 100-M that are coupled to a host device 200 through a network 300.

The network 300 may be a fabric network such as Ethernet, a fiber channel, or InfiniBand.

Each of the plurality of data processing apparatuses 100-1 to 100-M may correspond to the data processing apparatus 100 illustrated in FIGS. 1 and 2.

The host device 200 may transmit a request related to data processing and an address corresponding to the request to the data processing apparatuses 100-1 to 100-M. In some implementations, the host device 200 may transmit data to the data processing apparatuses 100-1 to 100-M. The data processing apparatuses 100-1 to 100-M may perform operations corresponding to the request of the host device 200 in response to the request, the address, and the data of the host device 200, and transmit a processing result to the host device 200.

It may require operations on vast amounts of data to process some applications such as big data analysis, machine learning, and others. The host device 200 may assign such operations to a near data processing (NDP) apparatus such as the data processing apparatuses 100-1 to 100-M such that the operations are processed in the near data processing (NDP) apparatus.

In some implementations of the disclosed technology, the data processing apparatuses 100-1 to 100-M may be configured to collect their resource statuses and voluntarily transmit the meta information including the resource statuses to the host device 200. Before offloading the application processing, the host device 200 may scan the meta information transmitted from at least one of the data processing apparatuses 100-1 to 100-M and select a data processing apparatus suitable for offloading of application processing among the data processing apparatuses 100-1 to 100-M. Then, the host device 200 may offload the application processing to the selected data processing apparatus. In an embodiment, the suitable data processing apparatus 100-1 to 100-M may be selected based on a condition that the command queue is not full, the main processor is not busy, or a memory space in which host data is to be stored is ensured. The above conditions are examples only and other conditions can be considered to select the data processing apparatus for offloading the application. In some implementations, the suitable data processing apparatus may be selected by considering at least one of a status of the command queue and a status of the main processor.

The host device 200 may transmit an instruction and data to the data processing apparatus 100-1 to 100-M that has been selected for offloading of application processing. The data processing apparatus 100-1 to 100-M may store data transmitted from the host device 200 in the memory module M[X] by referring to address information of the memory module M[X] included in the meta information transmitted to the host device 200, perform an operation on the data, and transmit an operation result to the host device 200.

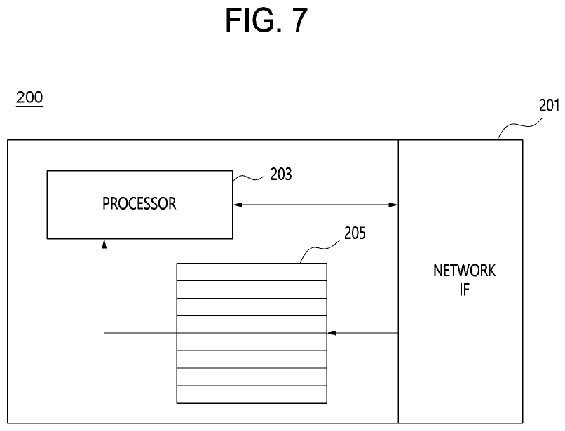

FIG. 7 is a diagram illustrating a configuration of the host device 200 based on an embodiment of the disclosed technology.

Referring to FIG. 7, the host device 200 may include a network interface 201, a processor 203, and meta information storage 205.

The network interface 201 may provide a communication channel through which the host device 200 accesses the network 300 and communicates with the data processing apparatuses 100-1 to 100-M.

The processor 203 may be configured to control an overall operation of the host device 200.

The meta information storage 205 may be configured to store meta information transmitted from at least one data storage apparatus 100-1 to 100-M.

When there is a request for an offload event from the host device 200, the processor 203 may select the suitable data processing apparatus 100-1 to 100-M by scanning the meta information storage 205. After the selection of the suitable data processing apparatus, the host device 200 offloads the application processing to the selected data processing apparatus.

When the suitable data processing apparatus 100-1 to 100-M is not found as a scanning result of the storage 205, the processor 203 may suspend an offload request or communicate with data processing apparatuses 100-1 to 100-M which do not transmit the meta information to collect the resource statuses. In an embodiment, the host device 200 may access some of the data processing apparatuses 100-1 to 100-M which do not transmit the meta information to collect the resource statuses by referring to the identifier field NDP ID of the data processing apparatus 100 included in the meta information.

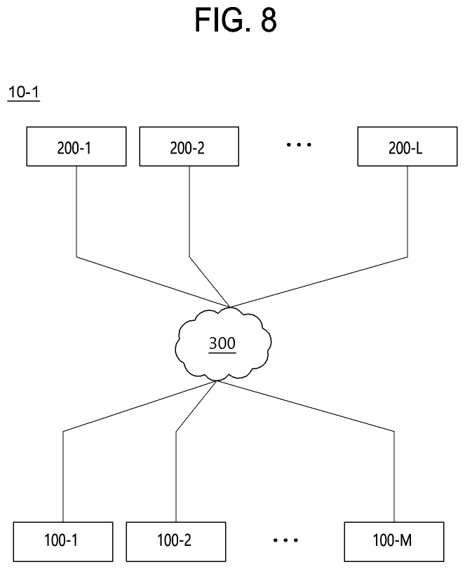

FIG. 8 is a diagram illustrating a configuration of a data processing system based on an embodiment of the disclosed technology.

In a data processing system 10-1 illustrated in FIG. 8, a plurality of data processing apparatuses 100-1 to 100-M and a plurality of host devices 200-1, 200-2, . . . , 200-L may be coupled through a network 300.

The network 300 may be a fabric network such as Ethernet, a fiber channel, or InfiniBand.

Each of the data processing apparatuses 100-1 to 100-M may correspond to the data processing apparatus 100 illustrated in FIGS. 1 and 2.

Each of the host devices 200-1 to 200-L may be configured similarly to the host device 200 of FIG. 7 to receive and store the meta information from the plurality of data processing apparatuses 100-1 to 100-M. Thus, the host devices 200-1 to 200-L select the suitable data processing apparatus 100-1 to 100-M based on the meta information before offloading the application processing.

When the data processing apparatus 100-1 to 100-M suitable for a request of offload-processing is not found, the host devices 200-1 to 200-L may access some of the data processing apparatuses 100-1 to 100-M which do not transmit the meta information to collect the resource statuses.

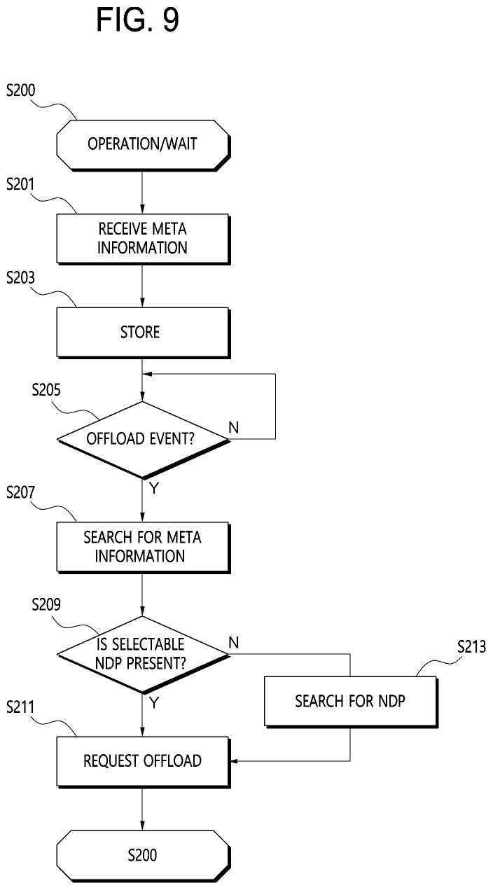

FIG. 9 is a flowchart explaining an operating method of a host device based on an embodiment of the disclosed technology.

During an operation or waiting (S200), the host device 200 and 200-1 to 200-L may receive packets including the meta information from the data processing apparatuses 100-1 to 100-M through the network 300 (S201) and store the packets in the meta information storages 205 (S203).

The host device 200 and 200-1 to 200-L may monitor whether or not a request for an offload evet for assigning an operation processing to any one among the data processing apparatuses 100-1 to 100-M is generated (S205), and determine whether or not the suitable data processing apparatus 100-1 to 100-M is present S209 by searching for the meta information storage 205 (S207) when the request for the offload event is generated (S205:Y).

When the suitable data processing apparatus 100-1 to 100-M is present (S209:Y), the host device 200 and 200-1 to 200-L may offload application processing to the corresponding data processing apparatus 100-1 to 100-M (S211). Then, the host device 200 and 200-1 to 200-L may perform a processing operation or transit to a wait state (S200).

When the suitable data processing apparatus 100-1 to 100-M is not present (S209:N), the host device 200 and 200-1 to 200-L may communicate with the data processing apparatuses 100-1 to 100-M to collect the resource statuses or to suspend an offload request until the suitable data processing apparatus 100-1 to 100-M is prepared. In an embodiment, the host device 200 and 200-1 to 200-L may access data processing apparatuses among the data processing apparatuses 100-1 to 100-M which do not transmit the meta information to collect the resource statuses by referring to the identifier field NDP ID of the data processing apparatus 100 which transmits the meta information S213.

The data processing systems 10 and 10-1 illustrated in FIGS. 6 and 8 may include a high-performance computing (HPC) device which performs an advanced operation in a cooperative manner using a super computer or a computer cluster, or networked information processing apparatuses or a server array configured to separately process data.

The data processing apparatuses 100-1 to 100-M constructing the data processing systems 10 and 10-1 may include at least one server computer, at least one rack constructing each server computer, or at least one board constructing each rack.

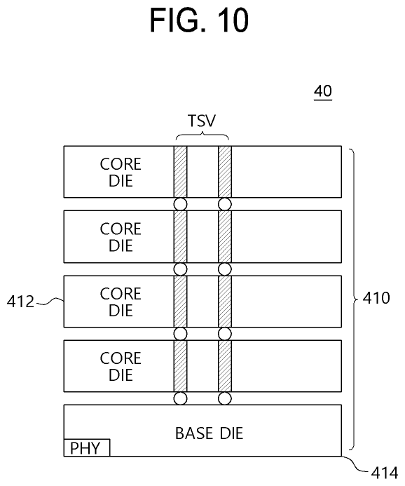

FIGS. 10 to 12 illustrate examples of stacked semiconductor apparatuses for implementing hardware for the disclosed technology.

FIG. 10 illustrates an example of a stacked semiconductor apparatus 40 that includes a stack structure 410 in which a plurality of memory dies are stacked. In an example, the stack structure 410 may be configured in a high bandwidth memory (HBM) type. In another example, the stack structure 410 may be configured in a hybrid memory cube (HMC) type in which the plurality of dies are stacked and electrically connected to one another via through-silicon vias (TSV), so that the number of input/output units is increased and thus a bandwidth is increased, which results in an increase in bandwidth.

In some implementations, the stack structure 410 includes a base die 414 and a plurality of core dies 412.

As illustrated in FIG. 10, the plurality of core dies 412 may be stacked on the base die 414 and electrically connected to one another via the through-silicon vias (TSV). In each of the core dies 412, memory cells for storing data and circuits for core operations of the memory cells may be disposed. The core dies 412 may constitute the memory pool 120 illustrated in FIGS. 1.

In some implementations, the core dies 412 may be electrically connected to the base die 414 via the through-silicon vias (TSV) and receive signals, power and/or other information from the base die 414 via the through-silicon vias (TSV).

In some implementations, the base die 414, for example, may include the controller 300 and the memory apparatus 200 illustrated in FIGS. 1 and 2. The base die 414 may perform various functions in the stacked semiconductor apparatus 40, for example, memory management functions such as power management, refresh functions of the memory cells, or timing adjustment functions between the core dies 412 and the base die 414.

In some implementations, as illustrated in FIG. 10, a physical interface area PHY included in the base die 414 may be an input/output area of an address, a command, data, a control signal or other signals. The physical interface area PHY may be provided with a predetermined number of input/output circuits capable of satisfying a data processing speed required for the stacked semiconductor apparatus 40. A plurality of input/output terminals and a power supply terminal may be provided in the physical interface area PHY on the rear surface of the base die 414 to receive signals and power required for an input/output operation.

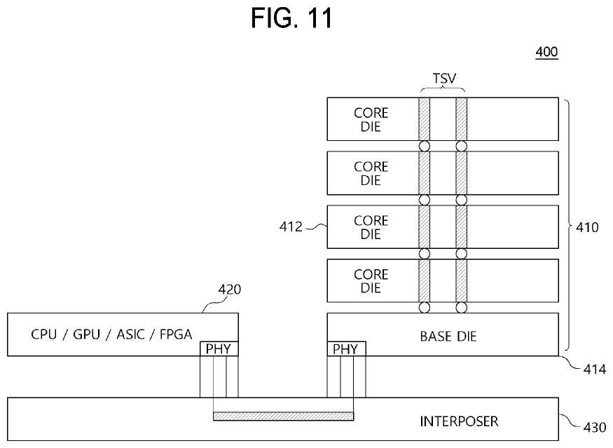

FIG. 11 illustrates a stacked semiconductor apparatus 400 in accordance with an embodiment.

The stacked semiconductor apparatus 400 may include a stack structure 410 of a plurality of core dies 412 and a base die 414, a memory host 420, and an interface substrate 430. The memory host 420 may be a CPU, a GPU, an application specific integrated circuit (ASIC), a field programmable gate arrays (FPGA), or other circuitry implementations.

In some implementations, the base die 414 may be provided with a circuit for interfacing between the core dies 412 and the memory host 420. The stack structure 410 may have a structure similar to that described with reference to FIG. 10.

In some implementations, a physical interface area PHY of the stack structure 410 and a physical interface area PHY of the memory host 420 may be electrically connected to each other through the interface substrate 430. The interface substrate 430 may be referred to as an interposer.

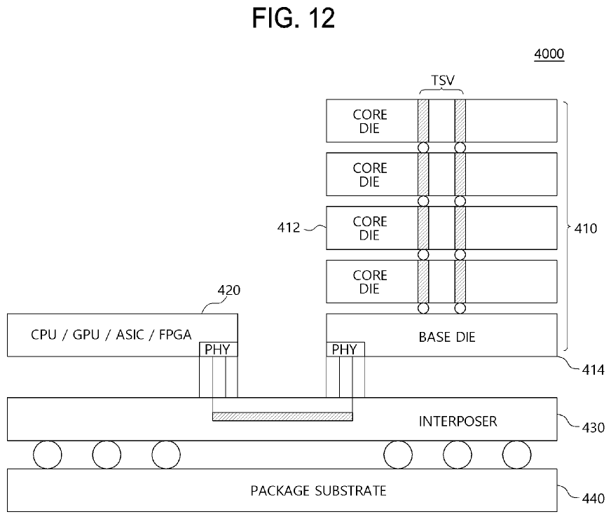

FIG. 12 illustrates a stacked semiconductor apparatus 4000 in accordance with an embodiment of the disclosed technology.

It may be understood that the stacked semiconductor apparatus 4000 illustrated in FIG. 12 is obtained by disposing the stacked semiconductor apparatus 400 illustrated in FIG. 11 on a package substrate 440.

In some embodiments, the package substrate 440 and the interface substrate 430 may be electrically connected to each other through connection terminals.

In some embodiments, a system in package (SiP) type semiconductor apparatus may be implemented by stacking the stack structure 410 and the memory host 420, which are illustrated in FIG. 11, on the interface substrate 430 and mounting them on the package substrate 440 for the purpose of packaging.

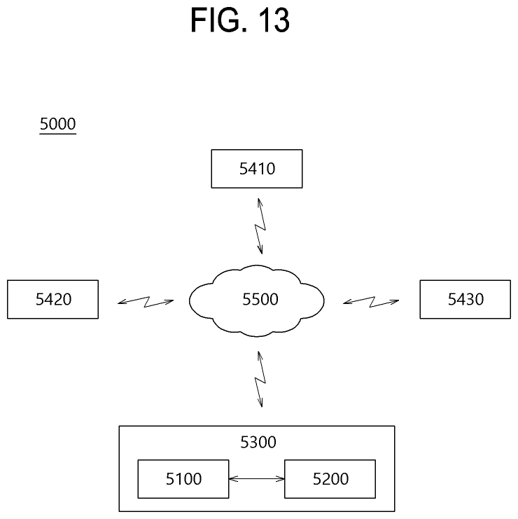

FIG. 13 is a diagram illustrating an example of a network system 5000 for implementing the neural network based processing of data of the disclosed technology. As illustrated therein, the network system 5000 may include a server system 5300 with data storage for the data processing and a plurality of client systems 5410, 5420, and 5430, which are coupled through a network 5500 to interact with the server system 5300.

In some implementations, the server system 5300 may service data in response to requests from the plurality of client systems 5410 to 5430. For example, the server system 5300 may store the data provided by the plurality of client systems 5410 to 5430. For another example, the server system 5300 may provide data to the plurality of client systems 5410 to 5430.

In some implementations, the server system 5300 may include a host device 5100 and a memory system 5200. The memory system 5200 may include one or more of the data processing system 100 shown in FIG. 1, the stacked semiconductor apparatuses 40 shown in FIG. 10, the stacked semiconductor apparatus 400 shown in FIG. 11, or the stacked semiconductor apparatus 4000 shown in FIG. 12, or combinations thereof.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described and other implementations, enhancements and variations can be made based on what is described and illustrated in this patent document.

What is claimed is:

1. A data processing apparatus, comprising:
a memory pool including a plurality of memory modules; and
a controller coupled to the memory pool through a bus, and
wherein the controller is configured to collect a status of a computing resource of the data processing apparatus, construct meta information indicating the status of the computing resource, and transmit the meta information to the host device coupled through a network.

2. The data processing apparatus of claim 1, wherein the controller is configured to exchange a protocol packet including the meta information with the host device.

3. The data processing apparatus of claim 1, wherein the controller is configured to exchange a control packet including the meta information with the host device.

4. The data processing apparatus of claim 3, wherein the controller is configured to monitor a traffic between the data processing apparatus and the host device and transmit the control packet including the meta information in case that the traffic is less than a threshold value or is in a communication idle state.

5. The data processing apparatus of claim 1, wherein the controller further includes a command queue configured to store commands transmitted from the host device, and
the meta information includes at least one of an identifier of the data processing apparatus, information indicating whether the command queue is full or empty, information indicating whether the controller is busy or idle, or an address of a memory module in which data of the host device is to be stored.

6. The data processing apparatus of claim 1, wherein the network including a fabric network including Ethernet, a fiber channel, or InfiniBand.

7. A data processing system, comprising:
a host device; and
a plurality of data processing apparatuses coupled to the host device through a network,
wherein at least one of the plurality of data processing apparatuses includes:
a memory pool including a plurality of memory modules; and
a controller coupled to the memory pool through a bus, and configured to monitor and collect a status of a computing resource of the at least one of the plurality of data processing apparatuses, construct meta information indicating the status of the computing resource, and transmit the meta information to the at least one host device.

8. The data processing system of claim 7, wherein the at least one of the plurality of data processing apparatuses and the host device are configured to exchange a protocol packet and a control packet therebetween, and
wherein the protocol packet or the control packet includes the meta information in the protocol packet or the control packet.

9. The data processing system of claim 7, wherein the host device includes:
a meta information storage configured to store the meta information received from the at least one of the plurality of data processing apparatuses; and
a processor configured to select a data processing apparatus based on the meta information and offload the application processing request to a selected data processing apparatus.

10. The data processing apparatus of claim 9, wherein the processor is configured to access another one of the plurality of data processing apparatuses through the network to collect the status of the computing resource of another one of the plurality of data processing apparatuses.

11. The data processing apparatus of claim 7, wherein the network includes Ethernet, a fiber channel, or InfiniBand.

12. A data processing system, comprising:
a data processing apparatus including a controller coupled to a memory pool including a plurality of memory modules through a bus, the controller configured to collect a status of a computing resource of the data processing apparatus, construct meta information indicating the status of the computing resource, and transmit the meta information; and
a host device coupled to the data processing apparatus through a network and configured to select a data processing apparatus based on the meta information and offload an application processing request to a selected data processing apparatus.

13. The data processing system of claim 12, wherein the controller is further configured to monitor a traffic between the data processing apparatus and the host device and transmit the meta information in case that the traffic is less than a threshold value or is in a communication idle state.

14. An operating method of a data processing system, comprising:
constructing, by a controller included in a data processing system that includes a plurality of memory modules coupled to the controller through a bus, meta information by collecting a status of a computing resource of the data processing system; and
transmitting, by the controller, the meta information to a host device coupled to the data processing system through a network.

15. The method of claim 14, wherein the transmitting of the meta information includes transmitting a protocol packet including the meta information.

16. The method of claim 14, wherein the transmitting of the meta information includes transmitting a control packet including the meta information.

17. The method of claim 16, further comprising: monitoring, by the controller, a traffic between the data processing apparatus and the host device, and
the transmitting of the meta information is performed in case that the traffic is less than a threshold value or is in a communication idle state.

18. The method of claim 14, wherein the controller further includes a command queue configured to store commands transmitted from the host device, and
the meta information includes at least one of an identifier of the data processing apparatus, information indicating whether the command queue is full or empty, information indicating whether the controller is busy or idle, or an address of a memory module in which data of the host device is to be stored.

19. The method of claim 14, wherein the host device is configured to receive meta information from additional data processing systems, and select one data processing system based on the meta information received from the data processing system and the additional data processing systems.

20. The method of claim 19, wherein the host device is further configured to access another data processing apparatus through the network to collect a status of a computing resource of another data processing apparatus.
